(19) United States
(12) Patent Application Publication
(10) Pub. No.: US 2020/0380935 A1
(43) Pub. Date: Dec. 3, 2020

(54) Automatic Display Orientation Configuration

(71) Applicant: Apple Inc., Cupertino, CA (US)

(72) Inventors: Michael C. Ignaszewski, Cupertino, CA (US); Robert L. Ridenour, Menlo Park, CA (US); Fateh Singh, Santa Clara, CA (US); Sandeep Ravi, Cupertino, CA (US); Adrian E. Sun, Mountain View, CA (US); Maria A. Tovar, Atherton, CA (US)

(21) Appl. No.: 16/887,521

(22) Filed: May 29, 2020

Related U.S. Application Data
(60) Provisional application No. 62/855,425, filed on May 31, 2019.

(51) Int. Cl. G09G 5/37; G06F 1/16

(52) U.S. Cl. CPC G09G 5/37; G06F 1/1622; G09G 2310/08; G09G 2340/0492; G06F 2200/1614

(57) ABSTRACT

Host content is received from a host device coupled to an external display device. The host content is displayed on the external display device when an orientation state of the external display device is a first orientation state. Change of the orientation state from the first orientation state to a second orientation state is detected, e.g., with a sensor. Orientation data corresponding to the second orientation state is transmitted to the host device. Host content, which has been transformed by a rendering pipeline configured at the host device based on the transmitted orientation data corresponding to the second orientation state, is received from the host device. The transformed host content is displayed on the external display device in response to the orientation state of the display device being changed to the second orientation state. In other embodiments, the display may be updated continuously during the orientation change.

### TECHNICAL FIELD

This disclosure relates generally to managing a display device coupled to a host device. More particularly, but not by way of limitation, this disclosure relates to setting a rendering pipeline and updating framebuffer contents in the host device based on orientation information received from the display device.

### BACKGROUND

Host devices such as desktop personal computers (PC), laptops, all-in-ones, tablet computers, portable digital assistants (PDAs), smart phones, and the like, have become ubiquitous. Host devices can be configured to send and receive e-mail, access the World Wide Web using a browser, and/or perform a wide variety of computing tasks. Many host devices (e.g., portable electronic devices) also include built-in displays that can be used by a user to interact with the host device, provide various types of input and/or control applications operating on the host device. For example, through input devices like a touchscreen, keyboard, mouse, stylus, and the like, a user can interact with user interface (UI) components that are virtually displayed on the built-in display of the host device. Functionality and utility of built-in displays may be limited due to display size and resolution constraints inherent in portable devices. Further, more powerful desktop computers may have capabilities to run resource-intensive applications, but may need high resolution external displays with ample screen size to interact with the user. Accordingly, it may be desirable to use external displays that are communicatively coupled to the host device to display content.

### SUMMARY

The following presents a simplified summary of the disclosed subject matter in order to provide a basic understanding of some aspects of the subject matter disclosed herein. This summary is not an exhaustive overview of the technology disclosed herein. It is not intended to identify key or critical elements of the invention or to delineate the scope of the invention. Its sole purpose is to present some concepts in a simplified form as a prelude to the more detailed description that is discussed later.

In one embodiment, a display device includes: a display panel; a sensor configured to detect an orientation state of the display device; memory; and one or more processors operatively coupled to the display panel, the sensor, and the memory, wherein the memory comprises instructions that, when executed by the one or more processors, cause the one or more processors to: receive host content from a host device communicatively coupled to the display device; display the host content on the display panel when the orientation state of the display device is a first orientation state; detect with the sensor that the orientation state of the display device has changed to a second orientation state; transmit orientation data corresponding to the second orientation state to the host device; receive from the host device, host content that has been transformed by a rendering pipeline that is set at the host device based on the transmitted orientation data corresponding to the second orientation state; and display the transformed host content on the display panel when the orientation state of the display device is the second orientation state. In another embodiment, the host content displayed on the display device being rotated may be continuously and dynamically updated so as to be continuously displayed with the correct orientation in synchronization with the rotation of the display device.

In yet another embodiment, a host device includes: memory comprising a framebuffer; and one or more processors operatively coupled to the memory, wherein the memory comprises instructions that, when executed by the one or more processors, cause the one or more processors to: receive orientation data corresponding to a current orientation state of a display device, wherein the display device is an external display device that is communicatively connectable to the host device via a coupling mechanism; set a rendering pipeline on the host device to transform host content based on the received orientation data corresponding to the current orientation state, and to render the transformed host content into the framebuffer; and transmit the transformed host content from the framebuffer to the display device.

In yet another embodiment, the instructions to cause the display device and/or host device to perform the techniques enumerated above may be embodied in computer executable program code and stored in a non-transitory storage device. In yet another embodiment, display device and/or host device may implement a corresponding method.

### BRIEF DESCRIPTION OF THE DRAWINGS

While certain embodiments will be described in connection with the illustrative embodiments shown herein, the invention is not limited to those embodiments. On the contrary, all alternatives, modifications, and equivalents are included within the spirit and scope of the invention as defined by the claims. In the drawings, which are not to scale, the same reference numerals are used throughout the description and in the drawing figures for components and elements having the same structure, and primed reference numerals are used for components and elements having a similar function and construction to those components and elements having the same unprimed reference numerals.

FIG. 1 is a block diagram of an embodiment of a computing system architecture adapted to perform orientation configuration operations for a display device.

FIG. 2 is a flowchart illustrating an embodiment of a method for performing orientation configuration operations for a display device.

FIG. 3 illustrates various display device orientation states and corresponding framebuffer content, in accordance with one or more embodiments.

FIG. 4 illustrates continuous rendering pipeline setting operation and framebuffer update operation based on a current orientation value of a display device, in accordance with one or more embodiments.

FIG. 5 is a simplified functional block diagram of an illustrative multi-functional electronic device, in accordance with one or more embodiments.

FIG. 6 shows, in block diagram form, a computer network, in accordance with one or more embodiments.

### DESCRIPTION

In the following description, for purposes of explanation, numerous specific details are set forth in order to provide a thorough understanding of the inventive concept. As part of this description, some of this disclosure's drawings represent structures and devices in block diagram form in order to avoid obscuring the invention. In the interest of clarity, not all features of an actual implementation are described. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” or “another embodiment” means that a particular feature, structure, or characteristic described in connection with the embodiment is included in at least one embodiment of the invention, and multiple references to “one embodiment” or “an embodiment” or “another embodiment” should not be understood as necessarily all referring to the same embodiment.

It will be appreciated that in the development of any actual implementation (as in any development project), numerous decisions must be made to achieve the developers' specific goals (e.g., compliance with system- and business-related constraints), and that these goals may vary from one implementation to another. It will also be appreciated that such development efforts might be complex and time-consuming, but would nevertheless be a routine undertaking for those of ordinary skill in the design and implementation of signal processing having the benefit of this disclosure.

The terms “a,” “an,” and “the” are not intended to refer to a singular entity unless explicitly so defined, but include the general class, of which a specific example may be used for illustration. The use of the terms “a” or “an” may therefore mean any number that is at least one, including “one,” “one or more,” “at least one,” and “one or more than one.” The term “or” means any of the alternatives and any combination of the alternatives, including all of the alternatives, unless the alternatives are explicitly indicated as mutually exclusive. The phrase “at least one of” when combined with a list of items, means a single item from the list or any combination of items in the list. The phrase does not require all of the listed items unless explicitly so defined.

This disclosure pertains to dynamically setting (e.g., adjusting, selecting, updating, changing, and the like) a rendering pipeline to transform host content and store the transformed host content in a framebuffer of a host device based on a current orientation state (e.g., orientation value, rotational value, rotational state, and the like) of an external display device coupled to the host device. Techniques disclosed herein look to update contents of the framebuffer on the host device by rendering transformed host content based on the current orientation state and the aspect ratio of the external display device. Rendering host content with the set rendering pipeline to transform the host content to a new orientation and drawing the transformed host content into the framebuffer on the host device ensures that the rendered host content is displayed on the rotated display device with the correct orientation while avoiding waste of screen space due to difference in aspect ratios between the rotated display device and the framebuffer. After the display device is rotated, the aspect ratio of the display device may be different from the aspect ratio of the framebuffer. In this case, if the display device were to transform the host content itself, the display device may have to resize or scale the host content to fit the larger dimension (e.g., width) of the framebuffer on the smaller dimension of the rotated display device. This may cause wasted screen space (e.g., in the form of vertical or horizontal black bars on sides of the display). Techniques disclosed herein look to overcome this problem.

The external display device may include a sensor (e.g., an on-board accelerometer) to detect changes to display orientation states (e.g., display rotated 0°, 90°, 180°, or 270° in a clockwise (CW) or counterclockwise (CCW) direction, and/or continuous orientation values (e.g., 37° clockwise, and the like)). The host device connected to the external display device may receive orientation data (e.g., value indicating display has been rotated 90° CCW) indicating a current orientation state of the display device, and control one or more components of the host device to set (e.g., adjust, select, change, update, and the like) the rendering pipeline to transform host content based on the received orientation data, and render the transformed host content into the framebuffer so as to update contents of the framebuffer. In one embodiment, during an initial boot mode, the host device may query the display device to obtain the current orientation state from the display device via a first connection pathway (e.g., DisplayPort®), and automatically set the rendering pipeline and update the framebuffer with transformed host content based on the obtained orientation state. (DisplayPort® is a registered trademark of the Video Electronics Standards Association, Calif., USA.) The host device may then transmit the rendered and transformed host content from the framebuffer to the display device for display.

Subsequently, during a standard operation mode, the display device may automatically monitor (e.g., detect) any changes in its orientation state, and transmit to the host device via a second connection pathway (e.g., USB), orientation data indicating a changed orientation state (e.g., value indicating display has been rotated back to 0°) of the display device when the rotation is detected. Based on the received orientation data, the host device may again automatically set the rendering pipeline to transform host content based on changed orientation state of the display device, and paint (e.g., draw, write, and the like) the transformed host content in the framebuffer in a direction that matches or conforms with the orientation state of the display device. The host device may then transmit the updated host content from the framebuffer to the display device for display. As a result, host content displayed on the display device may be automatically displayed in the correct way as the display device is rotated by the user. The user is thus not required to manually change any settings on the host device operating system (OS) or on the display device to cause the host content to be displayed correctly. Different host devices may perform orientation configuration operations for the display device using different communication pathways in different modes (e.g., boot mode, regular mode, and the like). Some host devices (e.g., tablet computer) may also perform orientation configuration operations for the display device using the same communication pathway in multiple different modes.

In one embodiment, the display device may be configured to detect a change in its orientation from a first orientation state (e.g., 0°) to a second orientation state (e.g., 90° CCW) when the rotation of the display device enclosure exceeds a a corresponding threshold orientation value (e.g., 60° CCW). That is, the display device may transmit the new orientation state (e.g., 90° CCW) when the rotation of the display device enclosure exceeds the tipping point value (e.g., threshold orientation value corresponding to the second orientation state) as detected by the sensor on-board the display device. In this case, upon receiving the new orientation state, the host device may set the rendering pipeline and update the framebuffer with rendered and transformed host content to start transmitting host content that is transformed and oriented (e.g., 90° CW) in the framebuffer for display based on the new orientation state (e.g., 90° CCW) of the display device. In one embodiment, the host device may animate the changes to the rendering pipeline and the update of the framebuffer over a predetermined number of steps so that the host content displayed on the rotated display device gradually animates to the correct orientation over a predetermined period of time. In another embodiment, the host device may set the rendering pipeline and update the framebuffer from the old orientation to the new orientation based on the received orientation data without animation so that the host content displayed on the display switches from the old orientation to the new orientation at the ‘tipping point’ after a ‘black-out period’ (e.g., correctly oriented image is displayed automatically after screen turns black briefly) without any animation.

The display device may also be configured to continuously transmit orientation states or orientation values thereof (e.g., 0°, 1°, 2°, . . . , 88°, 89°, 90° CCW) to the host device, and the host device may be configured to continuously set (e.g., select, update, change, adjust, and the like) the rendering pipeline, transform host content, render transformed host content, and paint the framebuffer with the rendered and transformed host content in a direction that conforms with the current orientation value, based on the orientation data continuously received from the display device. As a result, the host content displayed on the display device being rotated is continuously and dynamically updated so as to be continuously displayed with the correct orientation in synchronization with the rotation of the display device. This technique of continuously updating the display in synchronization with display device rotation may also allow the correction orientation to be set for host content even before the OS is loaded, e.g., during boot mode, safe mode, and the like.

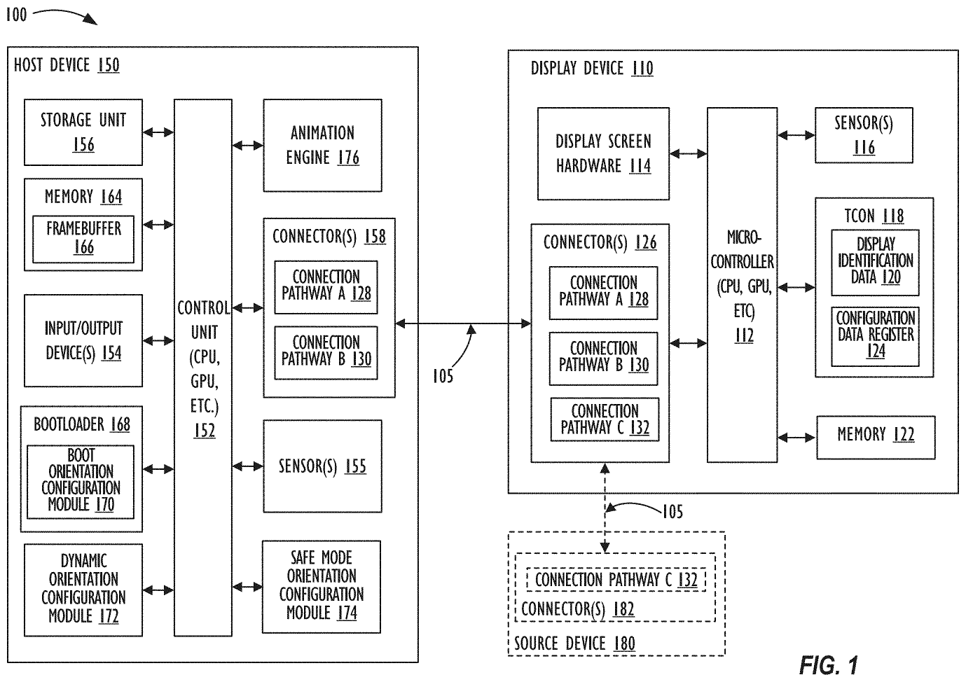

FIG. 1 is a block diagram of an embodiment of computing system architecture 100 adapted to perform orientation configuration operations for display device 110. Computing system architecture 100 may be implemented using a plurality of electronic components. Non-limiting examples of electronic components that implement system 100 include a desktop computer, a laptop computer, a tablet computer, an all-in-one computer, a server, a mobile phone, a smart phone, a media player, a personal digital assistant (PDA), a personal communicator, a gaming device, a network router or hub, a wireless access point (AP) or repeater, a set-top box, a television, a computer monitor, a display panel, and the like.

FIG. 1 illustrates that computing system architecture 100 encompasses display device 110 and host device 150. Display device 110 and host device 150 may be implemented as separate devices that can be connected via coupling mechanism 105 so as to enable information exchange between them. In one embodiment, coupling mechanism 105 can be a wired cable having opposing ends with connectors, which couple with corresponding connectors 126 and 158 in display device 110 and host device 150, respectively. For example, coupling mechanism 105 may be a display cable such as a high-definition multimedia interface (HDMI®) cable, a DisplayPort® cable, a Thunderbolt® cable, a universal serial bus (USB) cable, a digital visual interface (DVI) cable, a video graphics array (VGA) cable, an optical cable, or other display cable. (HDMI® is a registered trademark of HDMI Licensing LLC, San Jose, Calif., USA. Thunderbolt® is a U.S. registered trademark of Apple, Inc. of Cupertino, Calif., USA.) Coupling mechanism 105 can also be a wireless mechanism that communicatively couples display device 110 and host device 150 and enables exchange of information between the two devices.

Coupling mechanism 105 may enable communication between display device 110 and host device 150 based on one or more protocols. These protocols can be based on specifications written by standard setting organizations (SSOs), for example, a DisplayPort® specification, an HDMI® specification, a USB specification, a USB-C Power Delivery specification, an Internet Protocol (IP) specification, and the like. As shown in FIG. 1, display device 110 may also be connected to source device 180 via connector 126 of display device 110, connector 182 of source device 180, and coupling mechanism 105. Source device 180 may be similar to host device 150. For example, source device 180 may be a portable electronic device (e.g., smartphone or tablet computer).

As shown in FIG. 1, connectors 126,158, and 182 of display device 110, host device 150, and source device 180, respectively, may include one or more connection pathways (e.g., connection pathway A 128, connection pathway B 130, connection pathway C 132, and the like). Each connection pathway may correspond to a separate logical or physical communication link established between host device 150 and display device 110 under a corresponding standardized specification (e.g., DisplayPort® specification, HDMI® specification, USB specification, USB-C Power Delivery specification, IP specification, and the like). In the example embodiment shown in FIG. 1, display device 110 may be communicatively coupled with host device 150 via coupling mechanism 105, which may include (logical and/or physical) communication links corresponding to connection pathway A 128, and connection pathway B 130. In one embodiment, connection pathway A 128 may be a communication link established between host device 150 and display device 110 under the DisplayPort® specification, and connection pathway B 130 may be a communication link established between host 150 and display 110 under the USB specification. As also shown in the example embodiment of FIG. 1, display device 110 may be communicatively couplable with source device 180 via coupling mechanism 105, which may include a communication link corresponding to connection pathway C 132. In one embodiment, connection pathway C 132 may be a communication link established between source device 180 and display device 110 under the USB specification.

As shown in FIG. 1, display device 110 (e.g., display, external display device) may include microcontroller 112, display screen hardware 114, one or more sensors 116, and timing controller (TCON) chip 118, which stores display identification data 120 (e.g., EDID, DisplayID, and the like) and current display device orientation data (e.g., orientation state, orientation value, rotation value, and the like) in configuration data register 124. Display device 110 may further include memory 122 and connector 126, which may include a plurality of connection pathways (e.g., connection pathway A 128, connection pathway B 130, connection pathway C 132, and the like). Display screen hardware 114 (e.g., display panel) may correspond to a standard gamut or wide gamut display and may be used to display host content received from host device 150. For example, host content may comprise image, video, or other displayable content type (e.g., computer-generated data that includes text and graphic output as well as user interface data for receiving user input). The design and implementation of display screen hardware 114 may differ depending on the type of the display panel. Non-limiting examples of display panel types include liquid crystal displays, plasma displays, quantum dot-based displays, digital light processing based display (e.g., projector), and light emitting diode displays (e.g., organic light emitting diode displays), and the like. Display device 110 may include an enclosure (not shown) that houses screen hardware 114, as well as other components of display device 110.

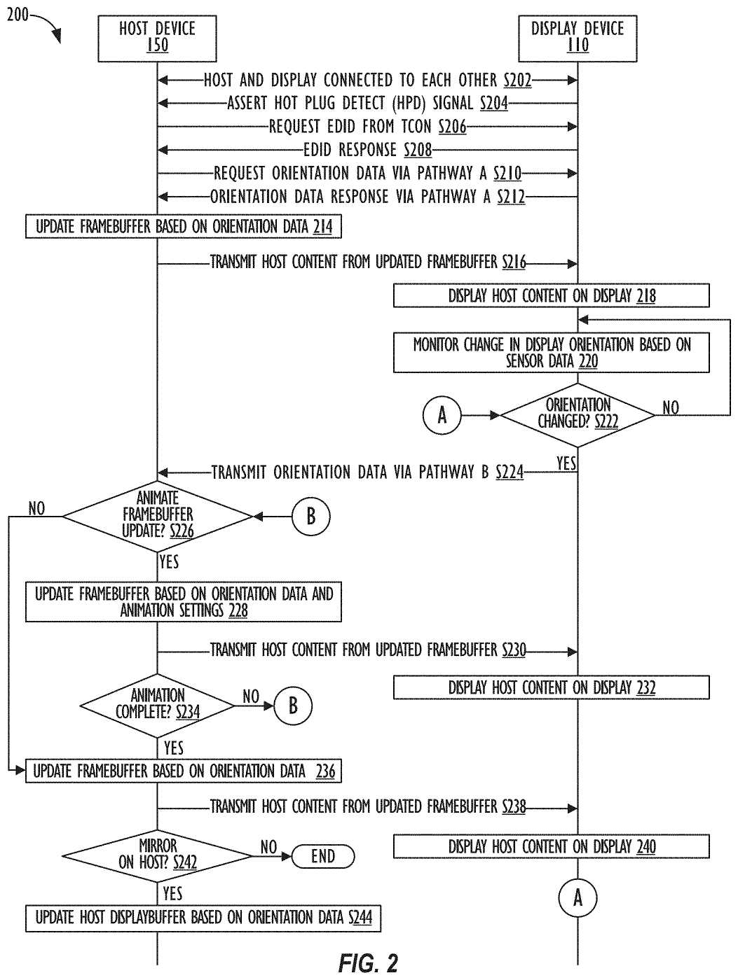

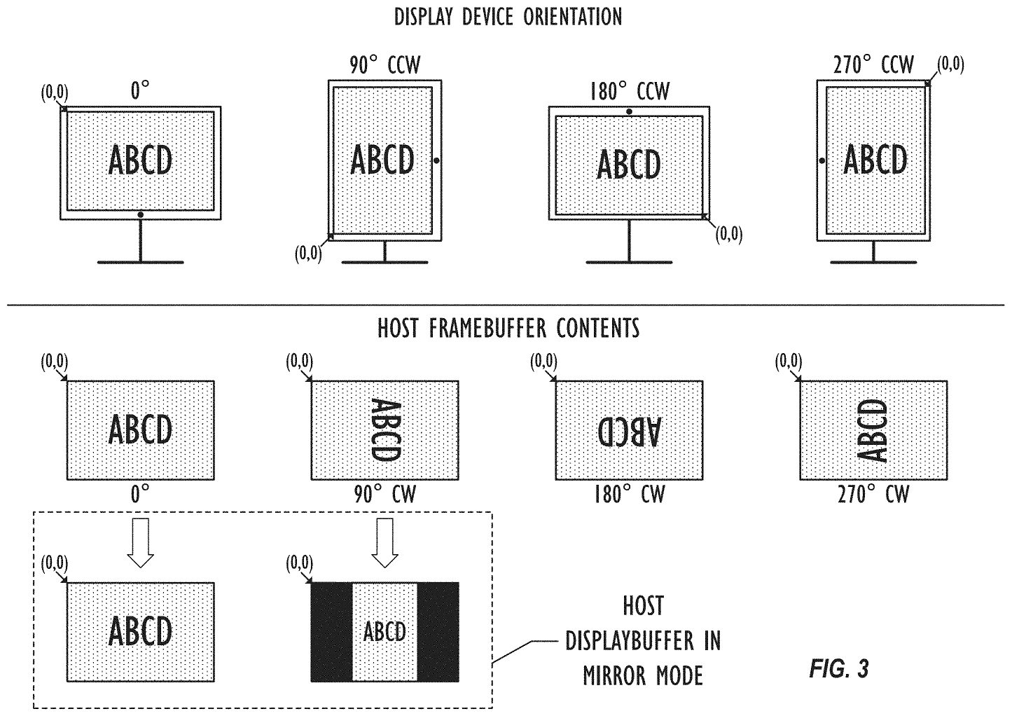

Display device 110 may be an external display device that can be coupled to a host device (e.g., host device 150, source device 180, and the like) via coupling mechanism 105 for receiving and displaying host content. Display screen hardware 114 of display device 110 may have different sizes, e.g., a 15″, 17″, 21″ screen and the like, and may have different aspect ratios, e.g., an aspect ratio of 4:3, 16:9, 21:9, and the like. In one embodiment, the enclosure of display device 110 may also include hardware components to configure or position display device 110 in different orientations. For example, the enclosure of display device 110 may include hardware components (e.g., stand, articulating mounts or joints, swivel brackets, ball joints, and the like) that enable rotation of the panel based on user operation (or automatically using electronic components such as motors and actuators) so as to selectively operate display device 110 in, e.g., a portrait mode, a landscape mode, and the like (see FIGS. 2 and 3).

Microcontroller 112 of display device 110 may include one or more processors (CPUs, GPUs, or other types of integrated circuits) and/or other type of system on chip (SoC) components to process host content. As an example, microcontroller 112 may include processing components, such as application specific integrated circuits (ASICs), field-programmable gate arrays (FPGAs), digital signal processors (DSPs), and memory for performing various image processing operations associated with an image or pixel processing pipeline and/or to instruct display screen hardware 114 to display host content. In one or more embodiments, microcontroller 112 may configure display device 110 as a smart display device that is able to perform one or more functions (e.g., scaling) that may be performed by image processors (e.g., CPUs, GPUs) of host device 150. Stated another way, depending on microprocessor's 112 processing capability and/or computing resources, host device 150 may offload one or more image processing tasks of the pixel processing pipeline to microcontroller 112 via coupling mechanism 105. Microcontroller 112 may also be configured as display driver circuitry, which can be used to display information via display screen hardware 114.

Sensors 116 may include one or more of proximity sensor/ambient light sensor, accelerometer, depth sensor, lidar, laser, IR, image sensor, temperature sensor, gyroscope, global positioning system sensor, peripheral device connection sensor, and the like. In one embodiment, an accelerometer sensor may be provided on-board display device 110 enclosure to automatically detect when display device 110 orientation changes. In one embodiment, display device 110 may inclue a mounted base attached to a ball joint, swivel, hinge, and the like, and connected to a display panel 114 such that display panel 154 may rotate freely to one or more positions, while remaining fixedly connected to the mounted base. For example, when a user operates display device 110 to physically rotate the display panel from a landscape orientation state to a portrait orientation state (FIGS. 2-4), accelerometer sensor 116 may be configured to continuously detect a current orientation value (e.g., 0°, 1°, 2°, . . . , 88°, 89°, 90°) or orientation state of display device 110 at each degree of rotation. Alternately, accelerometer sensor 116 may be configured to detect predetermined orientation states when the user operates display device 110 to physically rotate the display panel. For example, accelerometer sensor 116 may automatically detect when display device 110 reaches predetermined orientation states illustrated in FIG. 2 (e.g. 0°, 90°, 180°, and 270° CCW).

Timing controller (TCON) chip 118 may be provided on-board display device 110 for driving display screen hardware 114 and may store calibration information or other data used to apply corrections to host content output to the display panel. TCON 118 may also store display identification data 185 such as extended display identification data (EDID) or DisplayID data as a means of communicating display device capabilities to host devices. EDID and DisplayID are standards owned by Video Electronics Standards Association (VESA®). (VESA® is a registered trademark of Video Electronics Standards Association, Calif., USA.) EDID (or DisplayID) communicates display capabilities such as native resolution, video timing information, color space characteristics, and other information to host device 150. Information carried by EDID and DisplayID is known to those of skill in the art. When a host device connects to the display, the display's EDID may first be transmitted to the host to inform the host of what the display's capabilities are. EDID or DisplayID may include multiple standardized fields whose bits may indicate capabilities of the display device. Different fields of EDID or DisplayID may provide display device capability information including Vendor ID, Product ID, Manufacture Date, Serial Number, Display Size, color space the display receives (e.g., RGB, YCbCr, and the like), color gamut actually reproducible by the display device (e.g., sRGB, P3, and the like), timing formats (i.e., display resolutions and frame rates) the display can produce to present host content (e.g., 4K, 1080p, 720p, and the like).

In addition, TCON 118 may store in configuration data register 124, data (e.g., bits or codes) indicating a current orientation value or orientation state of display device 110 based on output from sensor 116. In one embodiment, configuration data register 124 may be a standardized specification configuration data register that stores transport capabilities of a communication link between host device 150 and display device 110 under a standardized specification (e.g., DisplayPort® specification, HDMI® specification, USB specification, USB-C Power Delivery specification, IP specification, and the like). For example, for a communication link between host device 150 and display device 110 under the DisplayPort® specification, register 124 may correspond to a DisplayPort® configuration data (DPCD) register that stores transport capabilities of a DisplayPort® link between host device 150 and display device 110. Configuration data register 124 may store the orientation data of display device 110 in an unused bit or location (field) thereof that is not being utilized by the corresponding standard or specification. In one embodiment, TCON 118 may be implemented as non-volatile storage. For example, TCON 118 may be implemented as a microcontroller that emulates a ROM.

Memory 122 may be implemented using any suitable (volatile and/or non-volatile) memory technology to store program instructions and data associated with display device 110. For example, program instructions may be configured to implement functionality associated with microcontroller 112, display screen hardware 114, sensors 116, connectors 126, and the like. Although not shown in FIG. 1, two or more of microcontroller 112, display screen hardware 114, sensors 116, TCON 118, memory 122, and connectors 126 may be communicatively coupled to each other via a communication fabric (e.g., a bus, a network, a switch, or an operating system inter-process communication mechanism). Display device 110 may be a standalone external display device such as a computer monitor, TV, and the like.

As shown in FIG. 1, system 100 also includes host device 150. Host device 150 may be a stationary or portable electronic device (e.g., a videogame console, a desktop computer, all-in-one computer, an Internet-of-Things (IoT) device, a laptop computer, a tablet computer, a wearable computer, a cellular telephone, a smartphone, etc.). Host device 150 can include functionalities of a communications device (e.g., a smartphone, a voice-over-IP device, etc.), a digital media player, a video game console, and/or a network appliance. Host device 150 may include control unit 152, input/output devices 154, one or more sensors 155, storage unit 156, connectors 158 (which may include connection pathway A 128, and connection pathway B 130), memory 164 (which may include framebuffer 166), bootloader 168 (which may include boot orientation configuration module 170), dynamic orientation configuration module 172, safe orientation configuration module 174, and animation engine 176. As shown in FIG. 1, host device 150 may be communicatively coupled with display device 110 and may provide host content residing in storage unit 156 and/or framebuffer 166 of memory 164 to display on display device 110.

Control unit 152 may include CPUs, GPUs, digital signal processors (DSPs), and/or other types of integrated circuits (ICs). Control unit 152 may also contain circuits such as memory, processors, application specific integrated circuits, and other storage and processing circuitry. For example, control unit 152 may be part of or are coupled to one or more other processing components, such as ASICs, FPGAs, and/or DSPs. Control unit 152 may also be configured to communicate with display device 110 (e.g., microcontroller 112, sensors 116, display screen hardware 114, and the like) via connector 158 and coupling mechanism 105. Control unit 152 may enable boot orientation configuration module 170, dynamic orientation configuration module 172, and safe mode orientation configuration module 174 to perform orientation configuration operations for display device 110.

Host device 150 may also include input/output devices 154. For example, input/output devices 154 may include at least one of the following: (i) one or more input devices that interact with or send data to one or more components of system 100 (e.g., mouse, keyboards, image capture devices/systems, ambient light sensor, wireless Bluetooth® peripheral, etc.); (ii) one or more output devices that provide output from one or more components of system 100 (e.g., internal or built-in monitors, printers, haptic feedback devices/systems, etc.); or (iii) one or more storage devices that store data in addition to memory 164 and storage unit 156. (Bluetooth® is a registered trademark of Bluetooth SIG, Inc, Washington, USA). Input/output devices 154 may combine different devices into a single hardware component that can be used both as an input and output device (e.g., a touchscreen, and the like). Sensors 155 may include one or more of proximity sensor/ambient light sensor, accelerometer, depth sensor, lidar, laser, IR, image sensor, temperature sensor, gyroscope, global positioning system sensor, peripheral device connection sensor, and the like.

Host device 150 may also include storage 156 and memory 164 for storing and/or retrieving data, which can include digital media, host content, data describing display device 110, orientation data, framebuffer data, rendering pipeline data, data associated with boot orientation configuration module 170, data associated with dynamic orientation configuration module 172, data associated with safe mode orientation configuration module 174, data associated with bootloader 168, data describing input/output devices 154, and/or metadata associated with the data.

Memory 164 of host device 150 may be implemented using any suitable (volatile and/or non-volatile) memory technology to store program instructions and data associated with host device 150. As shown in FIG. 1, memory 164 may include framebuffer 166. Framebuffer 166 may be a portion of memory 164 that contains a bitmap that drives display device 110. Framebuffer 166 may be a memory buffer containing a complete frame of rendered host content for driving display device 110. Host content stored in framebuffer 166 may be generated by a rendering pipeline implemented by one or more components of host device 150.

Host device 150 may include one or more applications that are running on host device 150 and that may act as authors who create host content that a viewer of display device 110 wishes to view. To display the host content on display device 110, the one or more applications may call and provide the host content to control unit 152 for rendering. Although not specifically shown, the one or more applications may utilize one or more application program interfaces (APIs) to interface with control unit 152, one or more graphics framework layers, and/or operating system (O/S) services. As an example, the one or more applications may issue a draw call and provide the host content to control unit 152 via an API.

In one embodiment, control unit 152 may implement the rendering pipeline to render the received host content using one or more processors and one or more GPUs. The processors may be implemented using one or more CPUs, where each CPU may contain one or more processing cores and/or memory components that function as buffers and/or data storage (e.g., cache memory). The processors may also be part of or are coupled to one or more other processing components, such as ASICs, FPGAs, and/or DSPs. Control unit 152 may be able to utilize the processors, GPUs, or simultaneously use both the GPUs and the processors to perform one or more steps or operations of the rendering pipeline to render the host content. The rendering pipeline implemented by control unit 152 may render host content based on the orientation and aspect ratio of the display. Thus, if the orientation and aspect ratio of the display changes, control unit 152 may adjust or update the rendering pipeline so as to render data for the new orientation and aspect ratio of the display. Control unit 152 may subsequently provide the rendered host content to framebuffer 166 for storing a complete frame of the rendered host content for display on display device 110.

In one embodiment, control unit 152 may set (e.g., adjust, select, update, change, and the like) the rendering pipeline to transform the host content based on the orientation state of display device 110. For example, control unit 152 may set (e.g., adjust, select, update, change, and the like) one or more steps or operations of the rendering pipeline so that the host content is transformed and resized based on a display space corresponding to the aspect ratio and the orientation state of display device 110. Control unit 152 may then store the transformed and resized host content rendered based on the set rendering pipeline in framebuffer 166. As a result, the host content gets ‘painted’ or ‘drawn’ into framebuffer 166 in a (changed) direction that causes the host content to display on the rotated display device 110 in the correct orientation.

Bootloader 168 may be implemented within host device 150 as hardware, software, or both. Bootloader 168 may include logic or code that is configured to run before an operating system (OS) associated with host device 150 begins to run. For example, bootloader 168 logic or code may contain multiple ways to boot OS kernel and contain commands for debugging and/or modifying the kernel environment. As shown in FIG. 1, bootloader 168 may include boot orientation configuration module 170. Each of boot orientation configuration module 170, dynamic orientation configuration module 172, and safe mode orientation configuration module 174 may be implemented within host device 150 as at least one of hardware (e.g., electronic circuitry associated with control unit 152, circuitry, dedicated logic, etc.), software (e.g., one or more instructions associated with a computer program executed by control unit 152, software run on a general-purpose computer system or a dedicated machine, etc.), or a combination thereof.

Boot orientation configuration module 170 may be configured to activate when host device 150 and display device 110 are communicatively coupled to each other and powered-on. In one embodiment, when host device 150 is in a boot mode (e.g., host device is powered-on and bootloader 168 is running to boot OS kernel, i.e., host device is ‘booting up’), boot orientation configuration module 170 may control one or more components of host device 150 to query the current orientation state of display device 110 via connection pathway A 128. For example, when connection pathway A 128 between host device 150 and display device 110 is implemented as a DisplayPort® communication link, boot orientation configuration module 170 may query a predetermined field of configuration data register 124 (e.g., DPCD register) of display device 110 to obtain data (e.g., bits or codes) indicating the current orientation state of display device 110. If boot orientation configuration module 170 determines based on the obtained orientation data that the rendering pipeline should be changed, boot orientation configuration module 170 may cause control unit 152 to set (e.g., adjust, change, select, and the like) the rendering pipeline to transform host content based on the obtained orientation data (e.g., rendering pipeline setting operation), and render the transformed host content into framebuffer 166 (e.g., framebuffer update operation). In one embodiment, the rendering pipeline setting operation and framebuffer update operation performed by boot orientation configuration module 170 in the boot mode may be GPU-unaccelerated operations, in which GPU processing is not available on host device 150. For example, in the boot mode, the rendering pipeline setting operation and framebuffer update operation may be performed in software.

For example, during the boot mode, host device 150 may be configured to display a ‘boot-upscreen’ including, e.g., OS logo, progress bar, login window, and the like, on display device 110. Based on the obtained orientation state of display device 110, boot orientation configuration module 170 may set the rendering pipeline and update framebuffer 166 contents so that the host content (e.g., OS logo and boot progress bar) is displayed on display 110 during boot-up with the correct orientation. Further, since boot orientation configuration module 170 caused the host content to be transformed and rendered by setting the rendering pipeline, waste of screen space due to difference in aspect ratios between rotated display device 110 and framebuffer 166 is avoided.

Dynamic orientation configuration module 172 may be configured to activate when host device 150 and display device 110 are communicatively coupled to each other and are in regular or normal operation (e.g., standard operation under control of OS of host device 150, after booting operations in the boot mode are completed). In one embodiment, when host device 150 is in a regular or standard mode (e.g., after host device 150 boot up), dynamic orientation configuration module 172 may control one or more components of host device 150 to receive the current orientation state of display device 110 via connection pathway B 130. For example, when connection pathway B 130 between host device 150 and display device 110 is implemented as a USB communication link, dynamic orientation configuration module 172 may continuously monitor and receive via a USB link, USB events including orientation data from display device 110 every time there is a change in display device's 110 orientation state or orientation value.

If dynamic orientation configuration module 172 determines based on the obtained orientation data that the orientation state has changed, dynamic orientation configuration module 172 may cause control unit 152 to dynamically set (e.g., adjust, update, change, select, and the like) the rendering pipeline to transform host content based on the obtained orientation data, render transformed host content, and update contents of framebuffer 166 with the transformed host content. For example, during the regular operation mode, host device 150 may be configured to display host content on display device 110 based on content output by one or more applications running on host device 150. Based on the obtained orientation state of display device 110, dynamic orientation configuration module 172 may cause control unit 152 to set the rendering pipeline and update framebuffer 166 so that the host content (e.g., content output by one or more host applications) is displayed on display 110 with the correct orientation. In this case also, since dynamic orientation configuration module 172 caused host content to be transformed by setting the rendering pipeline, waste of screen space due to difference in aspect ratios between rotated display device 110 and framebuffer 166 is avoided. In one embodiment, the regular mode may be a GPU-accelerated mode that relies on one or more GPUs of host device 150 to perform the rendering pipeline setting operations (e.g., rendering pipeline adjustment operations, rendering pipeline update operations, rendering pipeline change operations, rendering pipeline selection operations, and the like) and framebuffer update operations. For example, the rendering pipeline setting operations and framebuffer update operations of dynamic orientation configuration module 172 in regular operation mode may be performed in hardware and/or software.

Safe mode orientation configuration module 174 may be configured to activate when host device 150 and display device 110 are communicatively coupled to each other and are operating in a safe mode (e.g., OS installation mode, data recovery mode, diagnostic mode, and the like, where only essential application programs and services are allowed to start-up during boot). Safe mode orientation configuration module 174 may provide functionalities on host device 150 that are similar to those provided by dynamic orientation configuration module 172. In one embodiment, the safe mode may be a GPU-unaccelerated mode, in which GPU processing is not available on host device 150 to perform the rendering pipeline setting operations and framebuffer update operations of safe mode orientation configuration module 174.

Host device 150 may further include animation engine 176 to animate the operations of transforming host content by setting the rendering pipeline and updating framebuffer 166 over a predetermined number of steps so that the host content displayed on rotated display device 110 gradually animates to the correct orientation over a predetermined period of time. Animation engine 176 may determine the duration (predetermined period of time), over which the changes to the rendering pipeline are made and/or the ‘step size’ for the changes. Thus, animation engine 176 may cause the displayed host content to gradually arrive at the correct orientation, when display device 110 is rotated.

FIG. 1 also shows that display device 110 may be communicatively connectable to source device 180 via coupling mechanism 105. Source device 180 may be similar to host device 150, and may include one or more components similar to host device 150. For ease of explanation, features or components of source device 180 that may be similar to host device 150 are omitted here. As explained above in connection with host device 150, boot orientation configuration module 170 may obtain orientation data from display device 110 during boot mode via connection pathway A 128 of coupling mechanism 105, while during the regular mode (or safe mode), dynamic orientation configuration module 172 (or safe mode orientation configuration module 174) may obtain orientation data from display device 110 via connection pathway B 130 of coupling mechanism 105. That is, host device 150 may obtain orientation data from display 110 via different communication links operating under different standardized specifications (e.g., HDMI®, DisplayPort®, USB, and the like). This, however, may not necessarily be the case. For example, as shown in FIG. 1, source device may include a single connection pathway C 132, which may be used for obtaining orientation data from display device 110 in different modes including boot mode, regular mode, safe mode, and the like.

FIG. 2 is a flowchart illustrating an embodiment of method 200 for performing orientation configuration operations for display device 110. As shown in FIG. 2, method 200 begins at step S202 when host device 150 and display device 110 are connected to each other. For example, a display cable (HDMI®, Thunderbolt®, DisplayPort®, and the like) connected to display device 110 may be plugged into host device 150, and display device 110 and host device 150 may be powered-on. At step S202, host device 150 may enter boot mode while the OS kernel of host device 150 is booting up. Host device 150 may remain in boot mode until its OS begins to run.

At step S204, display device 110 may assert a hot plug detect (HPD) signal to indicate to host device 150 of the existence of display device 110. For example, at step S204, display device 110 may switch a HPD line from low level to high level so as to notify host device 150 that the display cable is normally connected, and that display device's 110 EDID (or DisplayID) related circuitry is activated so that access to EDID or DisplayID information is available for readout. Next, at step S206, host device 150 (e.g., operating in boot mode) may transmit an EDID or DisplayID information readout request to display device 110. Subsequently, in response to the readout request, display device 110 may transmit EDID or DisplayID information (display identification data 120) stored in TCON 118 to host device 150 (step S208). Host device 150 may then begin transmitting image/video data (e.g., host content) to display device 110 based on the received EDID or DisplayID information. At step S208, OS of host device 150 may still not have started running and host device 150 may still be in boot mode.

At step S210, while still in boot mode, host device 150 may request current orientation data via pathway A 128 from display device 110. For example, when connection pathway A 128 is implemented as a DisplayPort® communication link, at step S210, boot orientation configuration module 170 may query a predetermined field of configuration data register 124 (e.g., an unallocated field of the DPCD register) of display device 110 to obtain data (e.g., bits or codes) indicating the current orientation state of display device 110. For example, while host device 150 is still booting up, and before transmitting host content from framebuffer 166 for display on display device 110, boot orientation configuration module 170 may query display device 110 to obtain its orientation state when display device 110 is powered-on and communicatively connected to host device 150. For example, display device 110 may be configured to control accelerometer sensor 116 to determine its current orientation and store an orientation value indicating the current orientation state in register 124. Subsequently, in response to the orientation data request, display device 110 may transmit orientation information stored in register 124 of TCON 118 to host device 150 (step S212). In one embodiment, at step S212, display device 110 may transmit the orientation data via connection pathway A utilized by boot orientation configuration module 170 during boot mode orientation control. That is, orientation data of display device 110 may be transmitted through coupling mechanism 105 (e.g., wired cable), by which host device 150 and display device 110 are connected to each other.

Method 200 may then proceed to block 214 where boot orientation configuration module 170 may cause control unit 152 to set (e.g., adjust, select, change, update) the rendering pipeline to transform host content based on the received orientation value and render the transformed host content into framebuffer 166. Boot orientation configuration module 170 may then cause control unit 152 to transmit the transformed host content from framebuffer 166 to display device 110 for display (step S216) during boot mode. In one embodiment, at step S216, host device 150 may transmit host content via connection pathway A. At block 218, microcontroller 112 controls one or more components of display device 110 to display the host content received at step S216 during boot mode. For example, host device 150 may transmit contents of a screen to be displayed on display device 110 during boot mode (e.g., when host device 150 is booting-up) in the correct orientation by transforming host content in the rendering pipeline based on the orientation of display 110. This content may be displayed on display 110 so as to be easily viewable by the user of display 110 even while host device 150 is still booting up.

Method 200 may then proceed to block 220 where, during operation of host device 150 in regular mode (after boot-up), microcontroller 112 may control sensor 116 and continuously monitor (detect) change in orientation of display 110 based on sensor 116 data. For example, microcontroller 112 may obtain sensor data indicating the current orientation state or orientation value of display device 110 from sensor 116 every predetermined time period. Method 200 may then proceed to step S222 where microcontroller 112 may determine whether or not the orientation state of display device 110 has changed compared to a previous orientation value. For example, when a user manually rotates display device 110 (e.g., from landscape to portrait) in regular mode, sensor 116 may detect this change, and microcontroller 112 may determine at step S222 that the orientation state of display device 110 has changed during regular mode.

In one embodiment, microcontroller 112 may be configured to detect the orientation state change at step S222 (and/or control unit 152 may be configured to detect the current orientation state at step S212) based on the predetermined orientation states (that have been predefined and), for which the rendering pipeline setting operation and the framebuffer update operation can be performed by boot orientation configuration module 170, dynamic orientation configuration module 172, and/or safe mode orientation configuration module 174 of host device 150. Exemplary predetermined orientation states, for which the rendering pipeline setting operation and the framebuffer update operation can be performed by host device 150, are illustrated in FIG. 3.

FIG. 3 illustrates an embodiment of various predetermined display device orientation states and corresponding host framebuffer contents. As illustrated in FIG. 3, display device 110 may be configured to be operational in, e.g., four predetermined orientation states including: (i) a (default) orientation state in which display device 110 is operated in landscape with an orientation value of 0°; (ii) an orientation state in which display device 110 is operated in portrait while being rotated 90° counterclockwise (CCW) (or 270° clockwise (CW)); (iii) an orientation state in which display device 110 is operated in landscape while being rotated 180° CCW or CW; and (iv) an orientation state in which display device 110 is operated in portrait while being rotated 270° CCW (or 90° CW). While FIG. 3 illustrates four predetermined orientation states, this is not intended to be limiting. Alternative and/or additional predetermined orientation states may be devised, in which display device 110 is operational.

In another embodiment, microcontroller 112 may be configured to detect the orientation state change at step S222 (and/or control unit 152 may be configured to detect the current orientation state at step S212) based on the current orientation value determined based on sensor 116 data. That is, each degree of rotation of display device 110 may be detected at step S222 (or S212) as a new orientation state. When microcontroller 112 determines that the orientation state of display device 110 has not changed during regular mode (NO at step S222), microcontroller 112 may continue to monitor change in orientation of display 110 based on sensor 116 data.

When microcontroller 112 determines that the orientation state of display device 110 has changed during regular mode (YES at step S222), microcontroller 112 may control one or more components of display device 110 to transmit the changed orientation value or data via connection pathway B 130 to host device 150 (step S224). That is, orientation data of display device 110 may be transmitted through coupling mechanism 105 (e.g., wired cable). At step S224, microcontroller 112 may also store the detected orientation value representing the current orientation state in memory 122. For example, when connection pathway B 130 is implemented as a USB communication link, microcontroller 112 may dynamically transmit via a USB link the orientation data from display device 110 every time there is a change in display device's 110 orientation state as detected by sensor 116 and as determined by microcontroller 112. Host device 150 in the regular mode may also be configured to dynamically receive via connection pathway B 130 (e.g., as a USB event), the current orientation state of display device 110, and dynamic orientation configuration module 172 may continuously and dynamically set (e.g., adjust, change, update, select, and the like) the rendering pipeline to transform host content based on the received orientation data and update framebuffer 166 with the rendered and transformed host content.

Using the predetermined orientation states in FIG. 3 as an example, display device 110 may be configured to transmit its current orientation state (e.g., at step S212 or S224) by using a predefined structure where predetermined bits or codes in a predetermined field of the predefined structure respectively correspond to the predetermined orientation states of display device 110. Upon receipt of a particular bit or code in the predetermined field of the structure, host device 150 determines what the current orientation state of display device 110 is and performs rendering pipeline setting operations and framebuffer update operations accordingly. In one embodiment, host device 150 may store a plurality of rendering pipelines respectively corresponding to the different predetermined orientation states. In this case, instead of changing or adjusting the rendering pipeline to transform host content, host device 150 may simply select one of the rendering pipelines that corresponds to the current orientation state (as determined based on received orientation data) and transform host content based on the selected and set rendering pipeline, and render the transformed host content into framebuffer 166.

In one embodiment, during a transition period when display device 110 is being rotated from a first (predetermined) orientation state (e.g., 0°) to a second (predetermined) orientation state (e.g., 90° CCW), display device 110 may be configured to transmit as the current orientation state, orientation data corresponding to the previous orientation state (e.g., 0°) until the orientation of display device 110 reaches a ‘tipping point’ (e.g., 60° CCW). Once the orientation of display device 110 reaches the tipping point value (e.g., threshold orientation value corresponding to the new or current orientation state), display device 110 may be configured to start transmitting the new orientation state (e.g., 90° CCW) as the current orientation state.

Returning to FIG. 2, after host device 150 receives the changed orientation value or data via connection pathway B 130 at step S224, host device 150 may determine whether the rendering pipeline setting operation and the framebuffer update operation corresponding to the current set orientation state is to be animated (step S226). In one embodiment, the animation operation may be selectively enabled/disabled by a user of host device 150 via a user interface (not shown). When host device 150 determines that the rendering pipeline setting operation and the framebuffer update operation corresponding to the current set orientation state is to be animated (YES at step S226), dynamic orientation configuration module 172 and animation engine 176 may cause control unit 152 to animate the rendering pipeline setting operation and the framebuffer update operation over a predetermined number of steps (block 228), and transmit the rendered and transformed host content from the updated framebuffer 166 after every step via pathway B 130 (step S230) to display device 110. Display device 110 may display the received host content after every step of the predetermined number of steps (block 232) so that the host content displayed on rotated display device 110 gradually animates to the correct orientation over a predetermined period of time. Method 200 then proceeds to step S234 where animation engine 176 may determine whether or not the animation is complete. If the animation is not complete (NO at step S234), method 200 returns to block S226, and the operations at block/steps S228-S234 are repeated by host device 150 and display device 110.

If, on the other hand, host device 150 determines that the rendering pipeline setting operation and the framebuffer update operation corresponding to the current set orientation state is not to be animated (NO at step S226), dynamic orientation configuration module 172 may cause control unit 152 to dynamically set the rendering pipeline to transform host content based on the obtained orientation data and update contents of framebuffer 166 with the transformed and rendered host content (block 236). Further, at step S238, dynamic orientation configuration module 172 may transmit the current host content from the updated framebuffer 166 via pathway B 130 to display device 110, and at block 240, display device 110 may display the received host content based on the new orientation state. In one embodiment, display device 110 may replace the old host content displayed in the old orientation state with the new host content displayed in the new orientation state after a ‘black-out period’ where the screen turns black briefly. Further, as shown in FIG. 2, operations described in steps/blocks S220-240 may be performed repeatedly while monitoring for change in the orientation state and host content is displayed on display device 110 accordingly.

Method 200 may also include step S242 where host device determines whether or not host content displayed on external display device 110 is to be mirrored on an internal (e.g., built-in) display (not shown) of host device 150. For example, if host device 150 is a portable electronic device that includes a display screen, host device 150 may be configured (e.g., selectively based on user operation) so that content displayed on external display device 110 is mirrored onto the display screen of host device 150. In this case (YES at block S242), a display buffer corresponding to the internal (built-in) display screen of host device 150 may be updated based on the current orientation state of (external) display device 110.

Although FIG. 2 illustrates that the steps and blocks of method 200 are implemented in a sequential operation, other embodiments of method 200 may have two or more blocks/steps implemented in parallel operations. Further, in one or more embodiments, not all steps and blocks may need to be implemented, or the steps and blocks may be implemented in a different order, or additional/alternative steps and blocks may be implemented.

As shown in FIG. 3, when display device 110 is in a default orientation state (0°), since a display space of framebuffer 166 of host device 150 may have the same aspect ratio and orientation as that of the default orientation state of display device 110, host content may be rendered by the rendering pipeline without any transformation and the rendered host content may be stored in framebuffer 166. Further, in case host device 150 includes an internal built-in display screen, when display device 110 is in the default orientation state (0°), host device 150 may also store the rendered host content in the display buffer of the internal display screen without any transformation.

Further, as shown in FIG. 3, when display device 110 is rotated from the default orientation state to a vertical (portrait) orientation state by, e.g., rotating display device 110 in a counterclockwise direction by 90°, a display space of framebuffer 166 of host device 150 may now have an aspect ratio (e.g., 4:3) and orientation (e.g., landscape) that is different from the aspect ratio (e.g., 3:4) and orientation (e.g., portrait) of display device 110. Simply displaying contents of framebuffer 166 without any transformation may cause clipping of the host content and/or cause waste (e.g., vertical or horizontal black bars on sides) of a display space of display device 110. However, as explained above, when the change of orientation state of display device 110 is detected by sensor 166 on-board display device 110, the orientation data (e.g., code indicating current orientation to be 90°) is transmitted to host device 150, which then operates one or more components (e.g., boot orientation configuration module 170, dynamic orientation configuration module 172, or safe mode orientation configuration module 174) to set (e.g., adjust, select, and the like) a rendering pipeline based on the current orientation state and transform the host content, and render the transformed host content into framebuffer 166 so that framebuffer 166 is painted in a different direction (e.g., transformed host content painted in framebuffer 166 in a direction that is rotated 90 CW when display device rotated 90° CCW).

In this case, since host device 150 transforms the host content, newly created host content created based on the new orientation state and aspect ratio is stored in framebuffer 166, so as to fully utilize the display space on display 110 (e.g., display additional host content that was invisible in the previous orientation state.) Further, in case host device 150 includes an internal built-in display screen, when display device 110 is rotated 90° CCW to the vertical orientation state, host device 150 may also update contents of the display buffer of the internal display screen so as to display host content with the same (portrait) orientation and aspect ratio (e.g., 3:4) as display device 110. In this case, as shown in FIG. 3, since the internal display screen of host device 150 has not been rotated and may have a different aspect ratio (e.g., landscape), the display buffer may include vertical black bars to mirror the orientation and aspect ratio of display device 110.

FIG. 3 also shows orientation states where display device 110 is flipped from the default orientation state to a horizontal (landscape) orientation state by, e.g., rotating display device 110 in a counterclockwise direction by 180°, and a vertical (portrait) orientation state by, e.g., rotating display device 110 in a counterclockwise direction by 270°. As shown in FIG. 3, host device 150 may set the rendering pipeline, transform host content, and update framebuffer 166 with the new rendered host content so that framebuffer 166 is painted in respective corresponding directions (e.g., transformed host content rotated 180° CW in framebuffer 166 when display device is rotated 1800 CCW, and transformed host content rotated 270° CW in framebuffer 166 when display device is rotated 270° CCW).

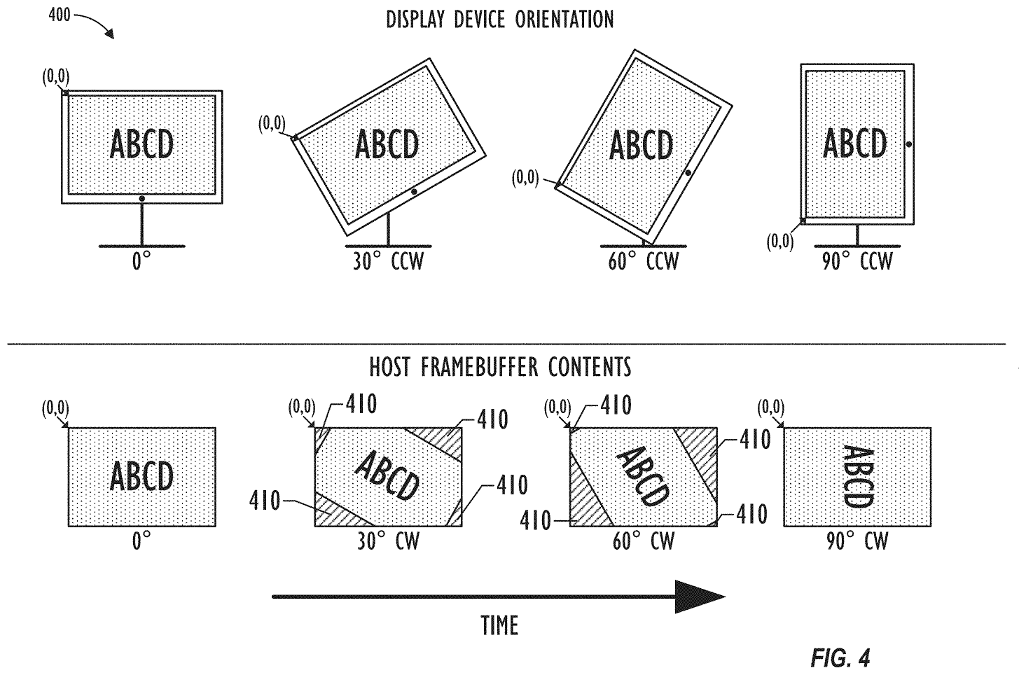

As explained above in connection with FIGS. 2 and 3, host device 150 may be configured such that the rendering pipeline setting operation and the framebuffer update operation can be performed by host device 150 in different modes (e.g., regular mode, safe mode, boot mode, and the like) for respective predetermined orientation states (e.g., four orientation states shown in FIG. 3) of display device 110. In another embodiment, display device 110 may also be configured to continuously transmit data corresponding to every degree of rotation of the changing orientation value of display device 110 (e.g., 0°, 1°, 2°, . . . , 88°, 89°, 90° CCW) to host device 150, while display device 110 is being flipped from, e.g., a landscape orientation to a portrait orientation. In this case, host device 150 may be configured to continuously perform the rendering pipeline setting operation and the framebuffer update operation for every degree of rotation based on the continuously received orientation values from display device 110. This may result in the orientation of the displayed host content continuously being corrected in synchronization with rotation of display device 110 so that while display device 110 is being rotated from, e.g., horizontal to vertical state, the host content is continuously updated and displayed on display device 110 with the corrected orientation. This embodiment is explained in further detail below in connection with FIG. 4.

FIG. 4 illustrates continuous rendering pipeline setting operation 400 and framebuffer update operation based on current orientation value of display device 110, in accordance with one or more embodiments. FIG. 4 shows display device 110 is rotated by 90° in the counterclockwise direction from its default orientation state of 0° (while display 110 is operating in any of the boot mode, regular mode, safe mode, and the like). As shown in FIG. 4, as display device 110 enclosure is rotated, the on-board sensor 116 may continuously detect the current orientation value (e.g., 0°, 1°, 2°, . . . , 88°, 89°, 90° CCW) and continuously transmit the current detected value to host device 150, in real-time.

Further, host device 150 may continuously set (e.g., adjust, select, update, and the like) the rendering pipeline to transform host content based on the received orientation value, and store the transformed and rendered host content in framebuffer 166. As a result, as shown in FIG. 4, when rotation of display device 110 reaches 30° in the CCW direction, host content may be drawn into framebuffer 166 in a direction that is oriented 30° in the CW direction in relation to the direction that content was drawn when display device 110 was in the default orientation state. Similarly, as shown in FIG. 4, when rotation of display device 110 reaches 60° in the CCW direction, host content may be drawn into framebuffer 166 in a direction that is oriented 60° in the CW direction in relation to the direction that content was drawn when display device 110 was in the default orientation state.

In this case, the host content that gets drawn into regions 410 of framebuffer 166 may correspond to newly rendered host content that is now within the frame as a result of the transformation and that was previously out of the display space defined by the default orientation state. Depending on the application rendering the host content, regions 410 may also correspond to ‘blacked-out’ regions where no content is displayed. In FIG. 4, regions 410 are marked with different cross-hatching than the rest of framebuffer 166 to show that regions 410 may include newly rendered host content that is newly displayable as a result of the transformation of the host content, or regions 410 may be ‘blacked-out’ regions, where no host content is displayed (depending on the source application). Although FIG. 4 illustrates the concept of continuously adjusting or setting the rendering pipeline in synchronization with the current rotational state of display device 110 by showing contents of framebuffer at 30° and 60°, it will be appreciated that other alternative or additional intermediate display device orientations and corresponding framebuffer contents can be shown.

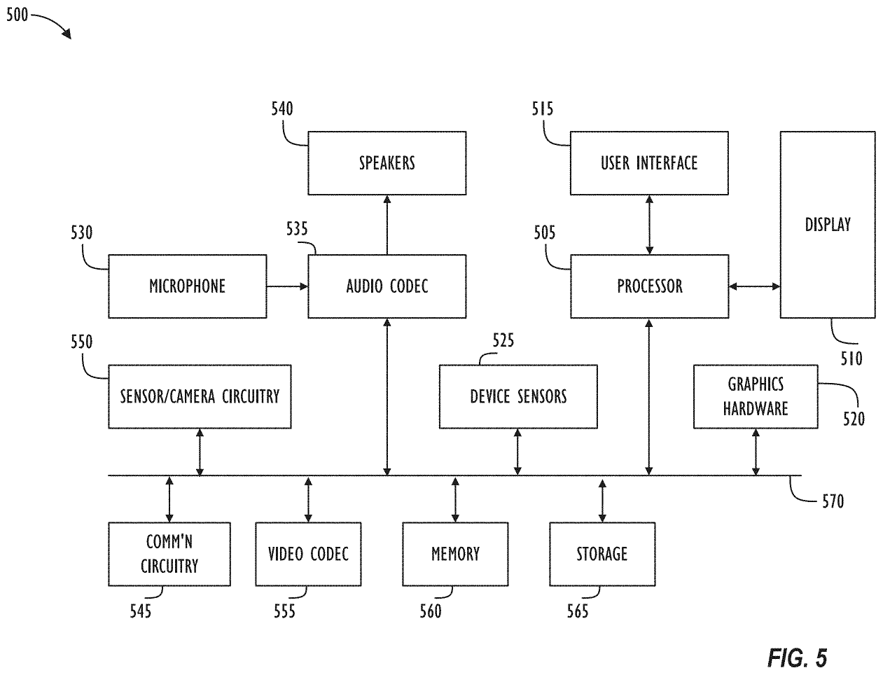

Referring to FIG. 5, a simplified functional block diagram of illustrative device 500 (e.g., host device 150 and/or source device 180 of FIG. 1, and the like) that performs display capability control operations as described in FIGS. 1-4 is shown. Device 500 may include processor 505, display 510 (e.g., display 110 of FIG. 1, and the like), user interface 515, graphics hardware 520, device sensors 525 (e.g., proximity sensor/ambient light sensor, accelerometer, depth sensor, lidar, laser, IR, and/or gyroscope), microphone 530, audio codec(s) 535, speaker(s) 540, communications circuitry 545, sensor and camera circuitry 550, video codec(s) 555, memory 560, storage 565, and communications bus 570. Electronic device 500 may be, for example, a digital camera, a personal digital assistant (PDA), personal music player, mobile telephone, server, notebook, laptop, desktop, or tablet computer. More particularly, the disclosed techniques may be executed on a device that includes some or all of the components of device 500.

Processor 505 may execute instructions necessary to carry out or control the operation of many functions performed by a multi-functional electronic device 500 (e.g., such as display orientation configuration operations and the like). Processor 505 may, for instance, drive display 510 and receive user input from user interface 515. User interface 515 can take a variety of forms, such as a button, keypad, dial, a click wheel, keyboard, display screen and/or a touch screen. Processor 505 may be a system-on-chip such as those found in mobile devices and include a dedicated graphics-processing unit (GPU). Processor 505 may represent multiple central processing units (CPUs) and may be based on reduced instruction-set computer (RISC) or complex instruction-set computer (CISC) architectures or any other suitable architecture and each may include one or more processing cores. Graphics hardware 520 may be special purpose computational hardware for processing graphics and/or assisting processor 505 process graphics information. In one embodiment, graphics hardware 520 may include one or more programmable graphics-processing unit (GPU), where each such unit has multiple cores.

Sensor and camera circuitry 550 may capture still and video images that may be processed to generate images in accordance with this disclosure. Sensor in sensor and camera circuitry 550 may capture raw image data as red, green, and blue (RGB) data that is processed to generate an image. Output from camera circuitry 550 may be processed, at least in part, by video codec(s) 555 and/or processor 505 and/or graphics hardware 520, and/or a dedicated image-processing unit incorporated within camera circuitry 550. Images so captured may be stored in memory 560 and/or storage 565. Memory 560 may include one or more different types of media used by processor 505, graphics hardware 520, and camera circuitry 550 to perform device functions. For example, memory 560 may include memory cache, read-only memory (ROM), and/or random access memory (RAM). Storage 565 may store media (e.g., audio, image and video files), computer program instructions or software, preference information, device profile information, and any other suitable data. Storage 565 may include one more non-transitory storage mediums including, for example, magnetic disks (fixed, floppy, and removable) and tape, optical media such as compact disc-ROMs (CD-ROMs) and digital video disks (DVDs), and semiconductor memory devices such as Electrically Programmable Read-Only Memory (EPROM), and Electrically Erasable Programmable Read-Only Memory (EEPROM). Memory 560 and storage 565 may be used to retain computer program instructions or code organized into one or more modules and written in any desired computer programming language. When executed by, for example, processor 805 such computer program code may implement one or more of the methods described herein.

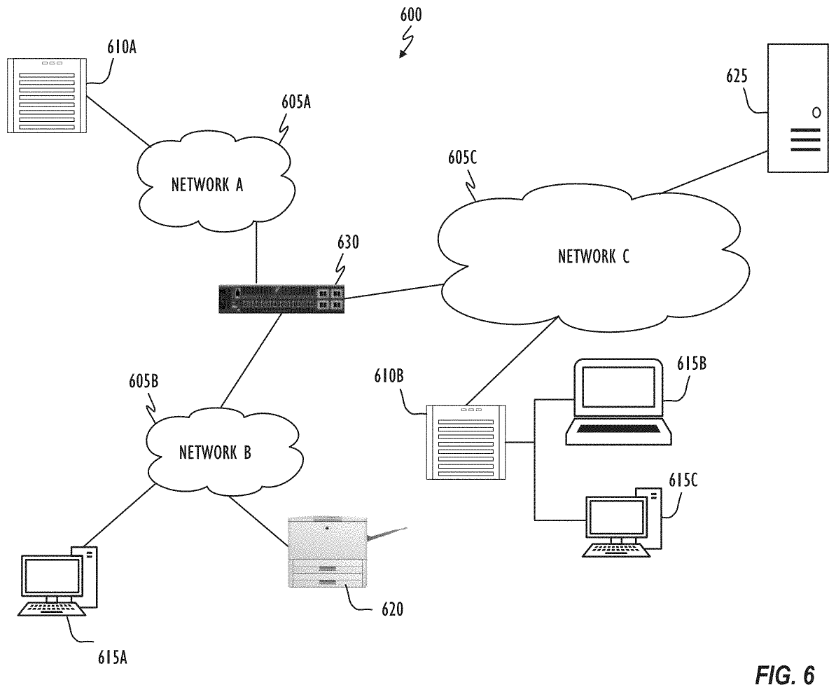

Referring to FIG. 6, illustrative network architecture 600, within which a system for performing display orientation configuration in accordance with the disclosed techniques may be implemented includes a plurality of networks 605, (e.g., 605A, 605B and 605C), each of which may take any form including, but not limited to, a local area network (LAN) or a wide area network (WAN) such as the Internet. Further, networks 605 may use any desired technology (wired, wireless or a combination thereof) and communication protocol (e.g., TCP, or transmission control protocol and PPP, or point to point). Coupled to networks 605 are data server computer systems 610 (e.g., 610A and 610B) that are capable of communicating over networks 605. Also coupled to networks 605, and/or data server computer systems 610, are client or end-user computer systems 615 (e.g., 615A, 615B and 615C). Each of these elements or components may be a computer system or electronic device as described above with respect to FIGS. 1-5. In some embodiments, network architecture 600 may also include network printers such as printer 620 and network storage systems such as 625. To facilitate communication between different network devices (e.g., server computer systems 610, client computer systems 615, network printer 620 and storage system 625), at least one gateway or router 630 may be optionally coupled there between.

As used herein, the term “computer system” or “computing system” refers to a single electronic computing device or to two or more electronic devices working together to perform the function described as being performed on or by the computing system. This includes, by way of example, a single laptop, host computer system, wearable electronic device, and/or mobile device (e.g., smartphone, tablet, and/or other smart device).

It is to be understood that the above description is intended to be illustrative, and not restrictive. The material has been presented to enable any person skilled in the art to make and use the claimed subject matter as described herein, and is provided in the context of particular embodiments, variations of which will be readily apparent to those skilled in the art (e.g., some of the disclosed embodiments may be used in combination with each other). In addition, some of the described operations may have their individual steps performed in an order different from, or in conjunction with other steps, than presented herein. More generally, if there is hardware support some operations described in conjunction with FIGS. 1-9 may be performed in parallel.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). The use of the term “about” means ±10% of the subsequent number, unless otherwise stated.

Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A display device comprising:
a display panel;
a sensor configured to detect an orientation state of the display device;
memory; and
one or more processors operatively coupled to the display panel, the sensor, and the memory, wherein the memory comprises instructions that, when executed by the one or more processors, cause the one or more processors to:
receive host content from a host device communicatively coupled to the display device;
display the host content on the display panel when the orientation state of the display device is a first orientation state;
detect with the sensor that the orientation state of the display device has changed to a second orientation state;
transmit orientation data corresponding to the second orientation state to the host device;
receive from the host device, host content which has been transformed by a rendering pipeline that is set at the host device based on the transmitted orientation data corresponding to the second orientation state; and
display the transformed host content on the display panel when the orientation state of the display device is the second orientation state.

2. The display device according to claim 1, wherein the display device is an external display device that is communicatively coupled to the host device via a coupling mechanism.

3. The display device according to claim 2, wherein the coupling mechanism includes a display cable that enables communication between the external display device and the host device based on one or more protocols that are based on one or more standardized specifications.

4. The display device according to claim 1, wherein the instructions that, when executed by the one or more processors, cause the one or more processors to detect that the orientation state of the display device has changed to the second orientation state comprise instructions that, when executed by the one or more processors, cause the one or more processors to:
detect a current orientation value of the display device based on data from the sensor; and
detect that the orientation state of the display device has changed from the first orientation state to the second orientation state based on an orientation value corresponding to the first orientation state, a threshold orientation value corresponding to the second orientation state, and the current orientation value.

5. The display device according to claim 1, wherein the instructions that, when executed by the one or more processors, cause the one or more processors to detect that the orientation state of the display device has changed to the second orientation state comprise instructions that, when executed by the one or more processors, cause the one or more processors to:
detect a current orientation value of the display device based on data from the sensor; and
detect that the orientation state of the display device has changed from the first orientation state to the second orientation state based on an orientation value corresponding to the first orientation state, and the current orientation value,
wherein the transformed host content is received and displayed on the display device dynamically with an orientation that is synchronized with rotation of the display device.

6. The display device according to claim 1, wherein the memory further comprises instructions that, when executed by the one or more processors, cause the one or more processors to:
receive a query from the host device for a current orientation state of the display device; and
transmit orientation data corresponding to a current orientation state of the display device in response to the query.

7. The display device according to claim 6, further comprising a timing controller (TCON) chip including a configuration data register, wherein the orientation data corresponding to the current orientation state of the display device is stored in the configuration data register.

8. The display device according to claim 6, wherein the instructions that, when executed by the one or more processors, cause the one or more processors to receive the query from the host device for the current orientation state comprise instructions that, when executed by the one or more processors, cause the one or more processors to:
receive the query from the host device for the current orientation state via a first connection pathway that establishes a first communication link between the host device and the display device.

9. The display device according to claim 6, wherein the instructions that, when executed by the one or more processors, cause the one or more processors to transmit the orientation data corresponding to the current orientation state comprise instructions that, when executed by the one or more processors, cause the one or more processors to:
transmit the orientation data corresponding to the current orientation state via a first connection pathway that establishes a first communication link between the host device and the display device.

10. The display device according to claim 1, wherein the instructions that, when executed by the one or more processors, cause the one or more processors to transmit the orientation data corresponding to the second orientation state comprise instructions that, when executed by the one or more processors, cause the one or more processors to:
transmit the orientation data corresponding to the second orientation state via a second connection pathway that establishes a second communication link between the host device and the display device.

11. A host device comprising:
memory comprising a framebuffer; and
one or more processors operatively coupled to the memory, wherein the memory comprises instructions that, when executed by the one or more processors, cause the one or more processors to:
receive orientation data corresponding to a current orientation state of a display device, wherein the display device is an external display device that is communicatively connectable to the host device via a coupling mechanism;
set a rendering pipeline on the host device to transform host content based on the received orientation data corresponding to the current orientation state, and to render the transformed host content into the framebuffer; and
transmit the transformed host content from the framebuffer to the display device.

12. The host device according to claim 11, wherein the instructions that, when executed by the one or more processors, cause the one or more processors to set the rendering pipeline on the host device comprise instructions that, when executed by the one or more processors, cause the one or more processors to:
adjust the rendering pipeline on the host device so that the rendering pipeline transforms the host content based on the current orientation state of the display device.

13. The host device according to claim 11, wherein the instructions that, when executed by the one or more processors, cause the one or more processors to set the rendering pipeline on the host device comprise instructions that, when executed by the one or more processors, cause the one or more processors to:
select, from among a plurality of rendering pipelines on the host device, a rendering pipeline that is configured to transform host content for the current orientation state of the display device.

14. The host device according to claim 11, wherein the memory further comprises instructions that, when executed by the one or more processors, cause the one or more processors to:
query the display device for the current orientation state of the display device via a first connection pathway that establishes a first communication link between the host device and the display device,
wherein the orientation data corresponding to the current orientation state is received via the first connection pathway from the display device in response to the query.

15. The host device according to claim 14, wherein the instructions that, when executed by the one or more processors, cause the one or more processors to query the display device via the first connection pathway comprise instructions that, when executed by the one or more processors, cause the one or more processors to:
query the display device via the first connection pathway while the host device is in a boot mode.

16. The host device according to claim 14, wherein the memory further comprises instructions that, when executed by the one or more processors, cause the one or more processors to:
receive, via a second connection pathway that establishes a second communication link between the host device and the display device, orientation data corresponding to a new orientation state of the display device,
wherein the rendering pipeline is set based on the received orientation data corresponding to the new orientation state.

17. The host device according to claim 16, wherein the instructions that, when executed by the one or more processors, cause the one or more processors to receive the orientation data via the second connection pathway comprise instructions that, when executed by the one or more processors, cause the one or more processors to receive the orientation data via the second connection pathway while the host device is in a regular operation mode.

18. A method comprising:
receiving, at an external display device, host content from a host device communicatively coupled to the external display device via a coupling mechanism;
displaying the host content on the external display device when an orientation state of the external display device is a first orientation state;
detecting, with a sensor provided in the external display device, that the orientation state of the external display device has changed from the first orientation state to a second orientation state;
transmitting orientation data corresponding to the second orientation state to the host device;
receiving from the host device, host content that has been transformed by a rendering pipeline that is set at the host device based on the transmitted orientation data corresponding to the second orientation state; and
displaying the transformed host content on the external display device when the orientation state of the display device is the second orientation state.

19. The method according to claim 18, wherein the coupling mechanism includes a display cable that enables communication between the external display device and the host device based on one or more protocols that are based on one or more standardized specifications.

20. The method according to claim 18, further comprising:
receiving, via a first connection pathway that establishes a first communication link between the host device and the external display device, a query from the host device for a current orientation state of the external display device; and
transmitting, via the first connection pathway, orientation data corresponding to the current orientation state of the display device,
wherein the orientation data corresponding to the second orientation state is transmitted to the host device from the external display device via a second connection pathway that establishes a second communication link between the host device and the display device, and
wherein the first and second communication links are established via the coupling mechanism.
